(19) United States
(12) Patent Application Publication
(10) Pub. No.: US 2004/0098875 A1
(43) Pub. Date: May 27, 2004

(54) Picture placement apparatus

(76) Inventor: George Gould, Clifton, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/305,489

(22) Filed: Nov. 27, 2002

(51) Int. Cl. G01D 21/00

(52) U.S. Cl. 33/613

(57) ABSTRACT

A picture placement apparatus provides an accurate mark on a wall for where to place the wall anchor (or other functionally similar device) that will hold up the picture on the wall. The picture placement apparatus attaches to the back of the framed object via an adhesive. The adhesive is chosen so that the picture place apparatus can be removed from back side of the framed object without damage. In use, a support wire on the back of the framed object is placed in a groove of the arm of the picture placement apparatus and the picture placement apparatus is attached to the framed object. The framed object is then held against a wall in the location where it is to be hung. A marking implement on the end of the arm comes in contact with the wall and marks the spot where a hanging means is to be installed. The picture placement apparatus is then removed from the back of the picture.

### FIELD OF INVENTION

The present invention relates to a frame hanging aid and use. More particularly the present invention is an easy to use apparatus that will mark the exact spot in the wall where the hanging device for a frame object is to be placed.

### BACKGROUND OF THE INVENTION

Since objects to be hung on a wall generally include a frame by which they are supported, the object will comprise both artwork and frame (a framed object). As is well known in the art, it is highly desirable to be able to locate a framed object on a wall in the precise position chosen. This is difficult, however, because the framed object itself often hides a variety of attachment devices, such as cords or wires.

Hanging of framed objects such as paintings or other pictures presents a problem since the fastener is obstructed from view while the framed object is held against the supporting surface in the desired location. With the frame held at its desired position upon a wall, present methods for identifying the point at which a hanging device should be secured to the wall require complicated measuring or marking procedures. These procedures must take into account all of the factors of positioning, including vertical and horizontal placement, size and shape of the frame, location of the unseen cord or other attachment device, and estimation of the position that the attachment device will assume when holding the frame.

The procedure for properly locating a hanging device becomes more complicated when two or more nails, hooks or other hanging devices are used. Employing dual or multiple hanging devices greatly increases the stability of a hanging frame over the use of a single hanging device, thus minimizing slippage, tilt, or other undesirable positions of a hanging frame. However, locating the precise points for securing dual or multiple hanging devices to a wall, properly spaced and in the same horizontal plane, presently requires tools and skills that many individuals simply do not possess.

Some devices have been proposed for hanging objects on walls with hidden fasteners. Such hidden picture hanging devices are attached to the edge of a picture frame without bearing the weight of the frame and aid in the placement of a frame on a wall. Unfortunately, these devices can only be attached to frames are flat and not adorned with ornate woodwork. For details of such devices, refer to U.S. Pat. Nos. 6,185,831, 5,867,917, 4,473,957, and 4,220,309.

A picture hanging device has also been proposed for use with saw tooth type brackets. The device is releasably supported by the saw tooth bracket on the back of the frame. This device is limited to use with frames having a stationary support on the backside of the frame. For additional details, refer to U.S. Pat. No. 5,398,906.

Picture hanging devices have been proposed that have a handle that bears the combined weight of the frame and device when the frame is held against the wall by the device for placement. The entire weight of the frame is focused on the handle of the picture hanging device. This makes the use of the device awkward with all but the smallest frames. For details of such devices, refer to U.S. Pat. Nos. 5,180,135, 5,129,154, 4,893,776, 4,637,583, 4,445,756, and UK Pat. No. 2,351,660.

A picture hanging devices has been proposed that employs a stamp releasably attached through adhesive to the back of a picture frame. This device does not work with wire supports. For additional details, refer to U.S. patent application No. 2002/0066200.

It has also been proposed to hang pictures on a wall with a hanging device that is adhesively attached to the back of the frame and to the wall simultaneously. This picture hanging device provides no help in ensuring accurate picture placement. For additional details, refer to U.S. Pat. No. 4,336,884.

Accordingly, there exists a need for a convenient and effective picture placement apparatus for identifying the point or points at which a hanging device should be secured to a wall in order to support a frame at a precise pre-selected position. Further, there exists a need for such a picture placement apparatus that can be applied while the frame is conveniently at rest upon a floor or other suitable surface with its attachment means exposed and reachable. As will become apparent from the following, the present invention satisfies these needs.

### SUMMARY OF THE INVENTION

An embodiment of the present invention is an easy to use picture placement apparatus that marks the exact spot on a wall where a picture frame hanger is to be located. The picture placement apparatus is for use with any object supported by a frame. By way of example, and not as a limitation, the picture placement apparatus is useful for hanging a framed picture or a mirror.

It is an object of the present invention to provide an improved aid to hanging framed objects on a wall.

It is another object of the present invention to provide an easy to use picture placement apparatus that will mark the exact spot on a wall where the hanging device for a framed object is to be placed.

It is yet another object of the present invention to provide a picture placement apparatus that is readily attachable to the back of the frame structure of a framed object thereby preserving the frame.

It is an object of the present invention to provide a picture placement apparatus attaching to the back of a frame that does not support the weight of the frame and is reusable.

It is still another object of the present invention to provide a picture placement apparatus that can be applied to a frame while the frame is conveniently at rest upon a floor or other suitable surface with its attachment means exposed and reachable.

These and other objectives of the present invention will become apparent from a review of the general and detailed descriptions that follow. An embodiment of the present invention is a picture placement apparatus comprising an extended base with a front side and a back side and an arm attached to the front side of the extended base and projecting away from the base. At the end of the arm is a marking implement. The arm has a groove with a bottom located in its upper portion near the base such that the tip of the marking implement and the bottom of the groove share the same horizontal plane. The picture placement apparatus is attached to the framed object through adhesive affixed to the back side of the base. The adhesive is chosen so that the picture place apparatus can be removed from back side of the framed object. In use, a support wire on the back of the framed object is placed in the groove of the arm of the picture placement apparatus and the picture placement apparatus is attached to the framed object. The framed object is held against a wall in the location where it is to be placed. The marking implement comes in contact with the wall and marks the spot where a hanging means is to be installed.

### BRIEF DESCRIPTION OF THE DRAWINGS

FIG. 1 illustrates a side view of an embodiment of a picture placement apparatus showing a marking implement, a groove from which to suspend support wire, and an adhesive layer for attaching the picture placement apparatus to a frame.

FIG. 2 illustrates a front view of an extended base portion of a picture placement apparatus with a marking implement at the top.

FIG. 3 illustrates a view of a picture placement apparatus position on the backside of a frame with a support wire suspended over a groove.

FIG. 4 illustrates a side elevation view of a picture placement apparatus attached to a frame as the frame is positioned against a wall.

### DETAILED DESCRIPTION OF THE INVENTION

An embodiment of the present invention is a picture placement apparatus that marks the exact spot on a wall where a picture frame hanger is to be located.

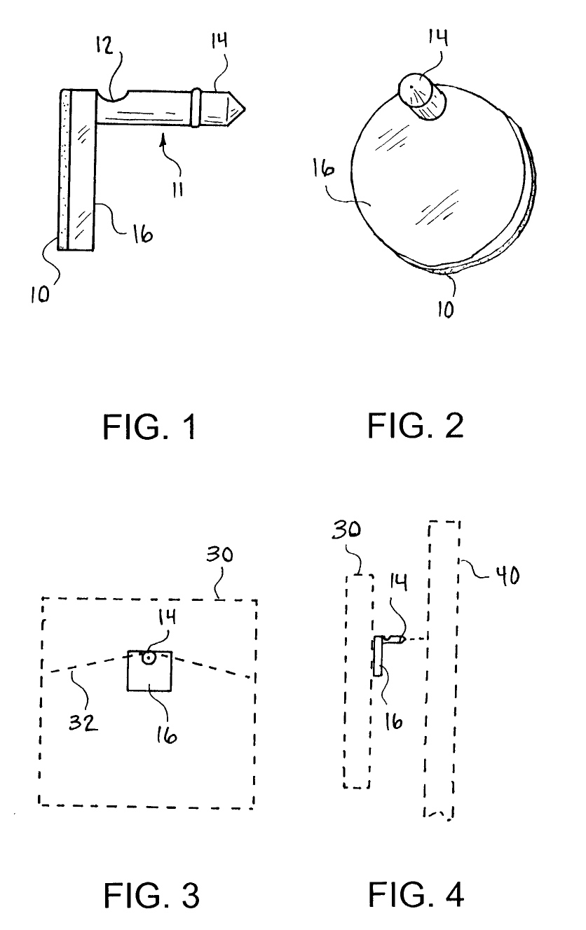

Referring first to FIG. 1, a side view of an embodiment of a picture placement apparatus is illustrated. An extended base 16 with an adhesive layer 10 affixed thereto for releasably adhering the extended base to the back of a frame is illustrated. An arm 11 projects away from the base and ends in a marking implement located at the tip 14 of the arm. A groove 12 is located on the upper portion of the arm for accepting a support wire 32 (see FIG. 3) typically found on the back of a frame 30 (see FIG. 3). The groove is dimensioned so that the bottom of the groove with the support wire resting therein is on the same plane as the tip of the marking implement. When the present invention is attached to the back of a frame with the support wire 32 (see FIG. 3) of the frame 30 (see FIG. 3.) resting in the groove 12 as described, the tip of the marking implement 14 will identify the position on a wall 40 (see FIG. 4) to locate a hanging means once the desired location is identified.

The adhesive layer 10 may be embodied as double-sided tape with one side that adheres permanently to the back side of the base 16, with the other side adhering less strongly to a picture frame or other object to be hung up. The adherence on the exposed side of the adhesive layer 10 has anisotropic adherence properties. That means that the adhesive layer 10 holds strongly when subjected to shear force along the plane of the back of the picture frame, yet it holds weakly when subject to a tension force pulling the picture placement apparatus away in a direction normal to the plane of the back of the picture frame.

According to another embodiment, the adhesive layer 10 comprises a so-called “stretch release” layer that adheres to a surface when applied to the surface with a compressive force, and which releases from the surface when stretched along the plane of the surface.

The hanging means can be any variety of frame support mechanism such as, but not limited to, picture hook, nail, nail with shield, molly bolt, and wall anchor.

Referring next to FIG. 2, a frontal view of an embodiment in FIG. 1 is illustrated. Illustrated is a base 16 with an adhesive layer 10 for adhesively affixing a picture placement apparatus to a framed object for placement on a mostly vertical surface. In this view, the arm 11 is projecting out of the page.

Referring next to FIG. 3, an embodiment of the present invention wherein the picture placement apparatus is attached to the back of the frame is illustrated. A support wire 32 typically found on the backside of the frame 30 is placed in the groove 12 (see FIG. 1) on the arm. Tension in the direction of the top of the frame 30 is placed on the support wire 32 and the wire is engaged in the groove 12 (see FIG. 1). In this embodiment, the base 16 is releasably affixed to the back of the frame 30 through the adhesive 10 (see FIG. 1).

It is noted that the base 16 is shown as having a circular shape in FIG. 2, and as having a rectangular shape in FIG. 3. These are alternate shapes for embodying the base 16. The base 16 may be embodied as an oval, or using the shape of any regular polygon, or in an irregular shape. It may even take on a shape such as to be a silhouette representation of an object, such as a key or an arrow.

Referring to FIG. 4, a side view of an embodiment of the present invention in use is illustrated. The marking implement 14 projects away from the base 16 towards the wall 40. When the frame 30 is positioned at the desired location on the wall, slight pressure is applied against the frame 30 in the direction of the wall 40 thereby causing the marking implement 14 to mark a point on the wall where a hanging means is to be located. In this fashion an accurate mark on the wall is achieved thereby facilitating the placement of the hanging means.

The marking implement is typically an elongate, rigid projection with a sharpened tip which marks a small point on the wall at the desired location for placement of the hanging means. The marking implement point can also be adapted to mark the wall with graphite, ink, or a similar pigmented-type marking material. A hanging means, (for example, a nail or similar picture supporting element) installed in the wall at the location marked by the marking implement 14 will suspend the picture at the desired location.

In another embodiment of the present invention, the arm 11 (see FIG. 1) is configured as a unitary structure with the marking implement 14 (see FIG. 1) a unitary and integrated part of the arm. In yet another embodiment, the marking implement is replaceable. In still another embodiment of the present invention, the arm is releasably positioned in different locations of the base 16 (see FIG. 1). By way of illustration and not as a limitation, the arm could be located in the middle of the base 16 or other location along the base 16.

The base 16 is advantageously configured so that there is sufficient adhesive surface to affix to the frame. The material from which the present invention may be constructed is not limiting and may be any material that is compatible with an adhesive and marking implement. Suitable materials include, but are not limited too, plastic, polymer, metal, and wood.

The length of the arm 11 (see FIG. 1) is not critical, so long as the arm will engage the wire 32 (see FIG. 3) and hold the marking implement 14 (see FIG. 1).

It is envisioned that heavy objects may require two or more hanging means to support the weight of the object on the wall. The present invention aids in the placement of heavy objects on a wall by precisely identifying the location where multiple hanging means need to be located so that the object rests against the wall at the desired height. By way of illustration and not as a limitation, two picture placement apparatuses may be employed to hang a large framed object. The wire support typically found on the backside of the framed object is engaged in the groove of each of the two picture placement apparatuses, and the bases of each picture placement apparatus is releasably attached to the back of the framed object. By lifting the framed object against the wall at the desired location and gently pressing the tip of the marking implements of the two picture placement apparatuses to the wall, the points at which two hanging means should be placed are identified. Accuracy is enhanced when that multiple devices are placed on the back of the frame at the same distance from the top of the frame to ensure that the object when hung is level. As would be apparent to those skilled in the art of the present invention, multiple picture placement apparatuses may be used without departing from the scope of the present invention.

An picture placement apparatus has now been illustrated. As described herein, the picture placement apparatus greatly simplifies locating the point where hanging means should be installed on a wall to support a framed object. It will be understood by those skilled in the art of the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible

What is claimed is:

1. A picture placement apparatus comprising:
a base with a front side and a back side;
an arm attached to the front side of the base and projecting away from the base;
a marking implement on an end of the arm distal from the base, the marking implement having a tapered tip;
a groove formed in an upper portion of the arm, the groove having a bottom located such that the tip of the marking implement and the bottom of the groove share a common horizontal plane; and
an adhesive member affixed to the back side of the base for releasably attaching to the back side of the picture to be placed.

2. The picture placement apparatus of claim 1, wherein the base is formed in a shape selected from the group consisting of oval, round, square, triangular, rectangular, and irregular.

3. A picture placement apparatus comprising:
a base with a front side and a back side;
an arm attached to the front side of the base and projecting away from the base;
a marking implement on an end of the arm distal from the base, the marking implement having a tapered tip;
a groove formed in an upper portion of the arm, the groove having a bottom located such that the tip of the marking implement and the bottom of the groove share a common horizontal plane; and
an adhesive member affixed to the back side of the base for releasably attaching to the back side of the picture to be placed;
wherein the base is formed from a material to which the adhesive means can permanently affix.

4. The picture placement apparatus as claimed in claim 3, wherein the apparatus is constructed from a material selected from the group consisting of wood, plastic, steel, and polymer.

5. The picture placement apparatus as claimed in claim 4, wherein the apparatus is constructed from wood, plastic, steel, or combinations thereof.

6. The picture placement apparatus as claimed in claim 1, wherein the marking implement is a unitary and integrated part of the arm.

7. The picture placement apparatus as claimed in claim 1, wherein the marking implement is replaceable.

8. The picture placement apparatus as claimed in claim 1, wherein the marking implement is a sharpened tip for marking a point on the wall at the desired location for placement of a hanging means.

9. The picture placement apparatus as claimed in claim 1, wherein the marking implement is graphite, ink, or a similar pigmented-type marking material.

10. The picture placement apparatus as claimed in claim 1, wherein the marking implement comprises at least one of graphite, ink or a similar pigmented-type marking material.

11. The picture placement apparatus as claimed in claim 1, wherein the marking implement comprised plural marking elements.
